(19) United States
(12) Patent Application Publication
(10) Pub. No.: US 2021/0070081 A1
(43) Pub. Date: Mar. 11, 2021

(54) DEVICE AND METHOD FOR IMPRINTING A DATA CARRIER

(71) Applicant: Muehlbauer GmbH & Co. KG, RODING (DE)

(72) Inventor: Franz Hoecherl, Rattiszell (DE)

(21) Appl. No.: 16/977,998

(22) PCT Filed: Mar. 11, 2019
(86) PCT No.: PCT/EP2019/055988

§ 371 Date: Sep. 3, 2020

(30) Foreign Application Priority Data
Mar. 15, 2018 (DE) 10 2018 002 113.1

(51) Int. Cl. B41M 3/14; B41M 3/00; B41M 7/00; B41J 2/21; B41J 11/00; G06K 1/12

(52) U.S. Cl. CPC B41M 3/14; B41M 3/008; B41M 7/0081; G06K 1/121; B41J 11/002; B41J 11/008; B41J 11/0095; B41J 2/2132

(57) ABSTRACT

A device and method for imprinting a data carrier including introducing the data carrier into a printer; moving the data carrier relative to a printing head to imprint an area of the data carrier using a first ink; moving the data carrier relative to a curing station in a first direction after the data carrier has been imprinted; drying the area of the data carrier in the curing station; moving the data carrier relative to the printing head in a second direction opposite to the first direction and imprinting the area of the data carrier using a second ink, where the imprint from using the second ink is different from the imprint from using the first ink.

### CROSS-REFERENCE TO RELATED APPLICATIONS

This application is a National Stage application of International Application No. PCT/EP2019/055988 filed on Mar. 11, 2019 which claims priority to German Patent Application Serial No. DE 10 2018 002 113 0.1 filed Mar. 15, 2018.

### BACKGROUND

### Field

A device and a method for imprinting a data carrier are disclosed here. In particular, an area of the data carrier to be imprinted with personal data by means of an inkjet printer, for example, is imprinted thereby. Aspects of the device and the method are defined both in the description and in the figures and the claims.

### Discussion of the Related Art

Data carriers of the type addressed here are security or identification documents such as passports, identity cards, driving licences, identification badges, credit cards, bank cards, payment cards, tags, access control cards and similar.

The data carriers of the type presented here, which are used as security or identification documents, are usually manufactured centrally except for their personalisation data and are then provided locally with personalisation, for example at registration offices, by authorities or in companies authorised to issue such documents. In the personalisation, personalisation data individually identifying the respective bearer of the security or identification document in the form of text, numerical and/or image data (for example, name and address of the bearer, date of birth, place of birth, photo of the bearer, biometric data of the bearer, etc.) as well as place and date of issue and period of validity of the document are entered into the security or identification document. These text, numerical and/or image data are at least partially directly legible for a viewer.

Although the manufacture of the data carrier and the insertion of the individual user data should be simple and inexpensive, the requirement exists that the cards should be designed with optimal protection against counterfeiting and corruption.

Apart from that, the printing process is to deliver a print product that is highly resistant to the effects of usage.

The technological background is to be gathered from WO 2017 120108 A1—Data card.

### SUMMARY

Starting out from this situation, a simple, inexpensive and robust arrangement and procedure for imprinting a data carrier, for instance a passport, is to be provided.

To solve this problem, devices or methods with the features and steps of the independent claims are proposed.

In particular, a method for imprinting a data carrier is proposed with the steps: introducing the data carrier, with the area to be imprinted exposed, into a printer, wherein a printing head having two or more inks to be printed onto the data carrier, and a curing station spatially remote from the printing head, are assigned to the printer; moving the data carrier relative to the printing head so that the printing head is able to imprint an area of the data carrier to be imprinted; imprinting of the area of the data carrier to be imprinted with personal data using at least a first of the inks; moving the data carrier relative to the curing station in a first direction after the data carrier has been imprinted with the at least one first ink, so that the curing station is able to act upon the area of the data carrier to be imprinted; at least partially surface drying the at least one first ink in the area of the data carrier to be imprinted in the curing station; moving the data carrier relative to the printing head in a second direction opposite to the first, so that the printing head is able to imprint an area of the data carrier to be imprinted; imprinting of the area of the data carrier to be imprinted using at least a second of the inks, wherein preferably the imprint using at least a second of the inks differs from the imprint using at least a first of the inks; removing the data carrier from the printer.

Another aspect relates to a device for imprinting a data carrier, having: a printer input, which is adapted and dimensioned to receive a data carrier with an exposed area to be imprinted; a printing head, which is adapted to imprint one or more inks to be printed onto the exposed area of the data carrier that is to be imprinted in a controlled manner; and a curing station, which is spatially remote from the printing head; a conveyor device, which is adapted and dimensioned to move the data carrier, the printing head and the curing station relative to one another, so that the printing head is able to imprint the area of the data carrier to be imprinted, and the curing station is able to act upon the imprinted area of the data carrier; a control device, which is adapted and programmed to cause the conveyor device to move the data carrier relative to the printing head, so that the printing head is able to imprint the area of the data carrier to be imprinted; to cause the printing head to imprint the area of the data carrier to be imprinted with personal data using at least a first of the inks; to cause the conveyor device to move the data carrier relative to the curing station in a first direction after the data carrier has been imprinted with the at least one first ink, so that the curing station is able to act upon the area of the data carrier to be imprinted; to cause the curing station to at least partially surface dry the at least one first ink in the area of the data carrier to be imprinted; to cause the conveyor device to move the data carrier relative to the printing head in a second direction opposite to the first, so that the printing head is able to imprint the area of the data carrier to be imprinted; to cause the printing head to imprint the area of the data carrier to be imprinted using at least a second of the inks, wherein preferably the imprint using at least a second of the inks differs from the imprint using at least a first of the inks; and to cause the conveyor device to remove the data carrier from the printer.

Here dimensions/shapes/positions of device components (e.g. data carrier intake, cover, frame) are also related to sizes/corresponding shapes of the data carrier. Although the data carrier is not part of the device, its dimensions and shapes are related to the device in its dimensioning and design as well as the use of the device. A data carrier of the type in question here is standardised to a certain extent in its shape, size or features, as it is a security or identification document such as a passport or passport booklet, identity card, driving licence, identification badge, credit card, bank card, payment card, tag, access control card, etc.

Data carriers can thus have the credit card format (ID-1), for example, which provides a length of 85.60 millimetres and a width of 53.98 millimetres (3.370 times 2.125 inches) for the card. This format has been used for decades for credit cards, telephone cards, credit cards, bank cards, payment cards. Driving licences and identity cards are also of ID-1 size in many countries.

Data carriers can also have the identity card format (ID-2), for example, which provides a size of 105 millimetres times 74 millimetres (4.125 times 2.875 inches) for the card. This corresponds to the DIN A7 format. Compared with ID-1, ID-2 offers somewhat more space, which can be used for a larger passport photograph or for additional physical security features.

Data carriers can also have in particular the passport format (ID-3) with a size of 125 millimetres times 88 millimetres (4.875 times 3.5 inches), thus corresponding to the DIN B7 format, which determines the size of passports globally.

The data page of a passport is divided into two areas: the visual zone and the machine-readable zone. The machine-readable zone has two rows of letters in the machine-readable OCR-B font. In the visual zone, the personal data of the bearer and a passport photograph are displayed. The most important of these data are repeated in the machine-readable zone.

Even data carriers that are subject to lower or no standardisation are clearly included here, however, as the limitations arising from the shape, size or features of the data carrier for the device result directly, so that the exact dimensions or features of the data carrier do not have to be included in the definition of the device or of the method. Nor is a definition of an explicit combination of data carrier and device required here.

In the UV printing process (UV=ultraviolet) used here, so-called UV-reactive or UV-curable inks are used as printing inks and a UV radiation source for curing the print image in the curing station.

The inks used here can contain a mixture of acrylate monomers, oligomers and photoinitiators, for example, as binders. Furthermore, the UV inks used here can be free of solvents and thinners.

When UV rays act upon the photoinitiators in the curing station, polymerisation is triggered in the binder of the inks. This leads to a chemical curing reaction and fixing of the freshly applied inks on the data carrier.

Due to this process, a layer of ink lies on the data carrier and the colours of the ink do not penetrate the data page of the data carrier, which page usually consists of synthetic material. This applies similarly to finished (lacquered or coated) paper, from which the page opposite the data page is normally formed. In the case of plain paper, the ink layer may penetrate.

The use of UV-reactive inks curable by UV light permits high production speeds with high ink qualities to be attained, even in the bright range of the colour space. Thus even prints of the passport photographs are possible in photorealistic image quality.

These UV-reactive inks are to be distinguished from the fluorescent UV ink likewise to be used here as ink, which can also be cured by UV light in the manner described here but is only visible under UV light in subsequent use of the data carrier.

The variants presented here are efficient, space-saving and offer a high throughput of imprinted data carriers. The variants presented here are also suitable for efficient integration into production sequences.

A compact machine is created here at manageable costs that produces an overlapping print using a single printer and dries the first print before the second print. To do this, the passport is transported back on the same path and imprinted afresh overlapping with the previous print.

The method presented here only requires one printer. If necessary, the drying of the ink after the first and the second print process can be carried out in separate drying stations or in one drying station. An inkjet printer, in particular a drop-on-demand inkjet printer, can be used as a printer.

A passport booklet is to be imprinted with a coloured, UV-curable inkjet printing facial image in the CMYK colour space, for example; a separate UV print can then be imprinted overlapping with this print. “Overlapping” in this context can mean that the imprinted ink areas at least partially overlap. This cannot take place in one step, as otherwise the wet CMYK and the UV-active inks of the inkjet printer smudge.

The already opened passport booklets are held ready in individual compartments above one another from a height-adjustable magazine. Alternatively, a magazine and a page-turning module for opening the passport booklet at the page to be imprinted can be provided. The electronic passport then passes through several process modules, for example a MRTD programming station (MRTD=Machine-Readable Travel Document) for chip coding, and a laser inscription station, to which a separate, non-transportable carriage can be assigned, in order to clamp the passport for the duration of the inscription by laser. On completion of the inscription of the data page by laser, the passport is conveyed from the carriage by a drive associated with the non-transportable carriage, which drive can be arranged underneath the non-transportable carriage, and is transferred to at least one drive roller located in a transfer section between the non-transportable carriage and the transportable carriage. From the drive roller in the transfer section the passport is then transferred to a drive associated with the transportable carriage in order to receive the passport in the carriage. Before the first print process/the printing head, the electronic passport is clamped in the open state in the transportable carriage and supplied to a camera. The seam of the passport booklet is oriented along the transport direction. The print area is thus narrower with the short edge of the data page. Furthermore, the data page and the front page of the passport are at the same place when the carriage turns the passport booklet under the laser station by 180 degrees.

A carriage can be movable in the longitudinal direction through an intake by conveyor rollers, between which the passport is transported. The carriage can compensate for the different thicknesses of the two passport halves by the provision of sprung bearing elements or blank holders in the carriage for each half of the passport.

During the movement of the passport booklet in the transport direction, the blank holders are activated, clamping the passport booklet. On output of the passport booklet following the curing station, the blank holders are opened accordingly. In the transport section of the output, a pair of drive rollers serves to convey the passport booklet out of the carriage.

The position of the passport is detected by means of the legend on the data page, other printed forms/security elements or by means of edge sections of the passport booklet that are not concealed by the blank holders. Depending on this, the printing head receives the print data for the CMYK image and position correction values. Measurement of the passport is optional.

The passport booklet is moved continuously through under the printer, which is not movable in at least one variant, is imprinted and only surface-dried by a subsequent, speed-adjustable curing station with UV LEDs. This curing is carried out for an adjustable period when the carriage passes a sensor, for example. It is substantial here that the duration of the surface drying is set such that the surface drying takes place only partially, whereby clear boundaries between the inks are avoided and the adhesion of the inks to one another is improved. In the event of complete drying, no reliable connection of the two prints (CMYK print image and UV-active print) is achieved.

In the following return transport of the passport booklet in the carriage under the printing head, the position and orientation of the passport booklet in the carriage relative to the printing head is measured afresh if a sensor is present. Based on the position and orientation data obtained, the printing head receives the print data for the UV image to be printed overlapping, separate from the CMYK print data. It is thus achievable that even errors in the pm range caused by any slippage of the passport or inaccurate printing of the first ink can be compensated for. A quality inspection of the previously printed CMYK image can optionally also take place at the same time.

The passport in the carriage is moved through under the printing head again and an overlapping print with UV-active ink is produced on the previous print with the CMYK ink, e.g. a QR code, facial image, coat of arms, code character, which contains information stored electronically or graphically in or on the passport, etc.

The passport booklet is then conveyed in the carriage afresh under the curing station and cured or completely dried using UV light rays.

In particular, the following sequence can be provided, to be precise preferably in the order indicated:
moving the passport booklet or the data carrier relative to the printing head in the first direction and imprinting the area of the data carrier to be imprinted with personal data using at least a first of the inks.
moving the data carrier relative to the curing station in the first direction and at least partial drying of the at least one first ink.
moving of the data carrier in the second direction opposite to the first direction.
moving the data carrier relative to the printing head in the first direction and imprinting the area of the data carrier to be imprinted using at least a second of the inks.
moving the data carrier relative to the curing station in the first direction and at least partial surface drying of the at least one second ink.

It is made possible in this way that imprinting of the data carrier using one ink and subsequent surface drying of the ink in the curing station takes place while the data carrier—starting out from a printing start position—is moved only in the first direction, thus within “outward transport” of the data carrier. The data carrier is then transported back in the second direction, thus return transportation of the data carrier takes place, until it is located in the printing start position again. This process can then be repeated for each print, so that one print takes place per outward transport of the data carrier.

Alternatively, the following sequence can be provided, for example, to be precise preferably in the order indicated:
moving the data carrier relative to the printing head in the first direction and imprinting of the area of the data carrier to be imprinted with personal data using at least a first of the inks.
moving the data carrier relative to the curing station in the first direction and at least partial surface drying of the at least one first ink.
moving the data carrier relative to the printing head in the second direction and imprinting of the area of the data carrier to be imprinted using at least a second of the inks.
it is enabled in this way that the data carrier is provided with a print both on the outward transport and on the return transport.
to dry the second print, the data carrier can then be moved back in the first direction.

It can also advantageously be provided here that the device also has another curing station, which is arranged so that the printing head is located between the first-mentioned curing station and the other curing station. The second print can then advantageously be surface-dried while the data carrier is still being moved in the second direction. A third print and surface drying of the third print can then be carried out during the next outward transport.

The movement of the data carrier in the first direction and the movement of the data carrier in the second direction preferably take place on the same path.

In one variant, in particular when the passport booklet is being moved through continuously under the printer, the printing head is not moved; instead it covers the entire width of the print area that is not concealed by the blank holders. The printing head can contain other UV inks or a transparent, UV-light-curable lacquer to seal the entire image on the surface of the data carrier in another through passage. For sealing, the previous print image can be dried partially or completely, and the passport booklet can be transported back in the carriage to the printing head again.

The printing head can also be aligned rotated by 90 degrees relative to the passport booklet in the carriage; the spine of the booklet can then be oriented transversely to the transport direction. In this case the printing head can have a drive for the movement transversely to the transport direction of the passport booklet.

The printing head can also have a drive and be positioned transversely to the transport direction of the passport booklet along a guide rail. The printing head in another variant can also be moved laterally beyond the carriage or the conveyor device, in order to print the same or different data from on the data page (on a protocol) there. It can be moved laterally beyond the carriage to perform auto-cleaning of the printer jet nozzles at intervals, for example by vacuum or compressed air, which joins the ink duct of the jet nozzle after the ink reservoir, and/or by a wiper, which is moved past the printer jet nozzles or past which the printer jet nozzles are moved.

Other advantageous embodiments of the devices and the methods result from the subordinate claims.

### BRIEF DESCRIPTION OF THE DRAWINGS

Other features, properties, advantages and functionalities of the devices and the methods are to be gathered from the following description in connection with the drawing. Possible modifications are also clear to a person skilled in the art on the basis of the description below, in which reference is made to the enclosed drawings. Here the figures show schematically the devices discussed here. Shown here are:

FIG. 1a is a schematic depiction of a data carrier of the type that can be processed by a device disclosed here in the form of a passport booklet from the outside;

FIG. 1b is a schematic depiction of a data carrier of the type that can be processed by a device disclosed here in the form of the data page located inside the passport booklet from FIG. 1a;

FIG. 2a is a schematic depiction of a device for imprinting a data carrier according to FIG. 1a, 1b with personal data by means of an inkjet printer; and

FIG. 2b is a schematic plan view of the device for imprinting the data carrier according to FIG. 2a

### DETAILED DESCRIPTION OF THE EMBODIMENTS

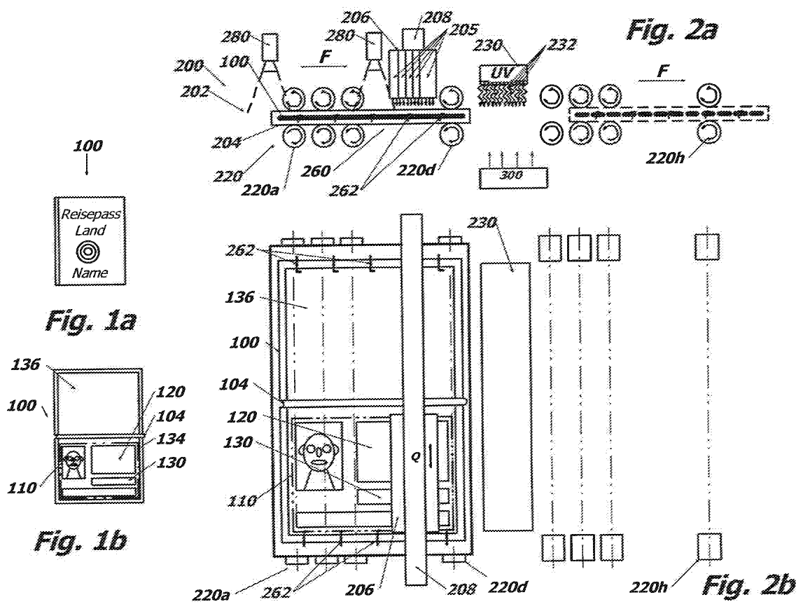

FIG. 1a shows a data carrier 100 in the form of a passport booklet in ID-3 passport format from outside, and FIG. 1b shows the data page 134 located inside the passport booklet of the data carrier 100 in the variant of the passport booklet from FIG. 1a. In particular, a photo image box 110 and a data field 120 are illustrated as well as an information area 130.

FIG. 2a illustrates schematically from the side a device 200 for imprinting the data carrier 100 in the variant as a passport booklet. This device 200 has a printer inlet 202, which in this configuration is adapted and dimensioned to receive the data carrier 100 in the folded-open state in a carriage 204 positioned in such a way that the area of the data carrier 100 to be imprinted, thus the photo image box 110, the data field 120 and the information area 130, for example, is exposed. In the present variant, the adjacent page of the passport booklet next to the data page is also exposed in addition. The fold or spine 104 of the passport booklet lies in the direction of transport of the passport booklet through the device 200. Furthermore, the (printer) device 200 has a printing head 206, here in the variant of an inkjet printing head, which comprises containers or tanks 205 with two or more inks. In the present example there are five containers for the inks “Cyan”, “Magenta”, “Yellow” and an ink black component “Key” (first inks), as well as an ultraviolet-light-active ink (second ink). These inks are all ultraviolet-light-curable inks in the variant shown here.

The printing head 206 is taken up on a rail 208 to move the printing head 206 using a drive, not illustrated further, transversely to the conveying direction F of the carriage 204 along the arrow Q (see FIG. 2b) from one side of the passport booklet to the other. The printer jets of the printing head 206 are controlled via a controller, not illustrated further, such that the first inks and the second ink can be printed in a controlled manner onto the exposed area of the data carrier 100 to be imprinted, in order to imprint personalisation data of the bearer (for example, date of birth, place of birth, photo of the bearer, biometric data of the bearer, along with place and date of issue and period of validity of the passport booklet). The first inks, the second ink and the third ink can be imprinted on the data page 134 and/or on the adjacent page 136, of paper.

To convey the data carrier 100 in the carriage 204 from the printer inlet 202 into the region of the device 100 where the printing head 206 is able to imprint the area of the data carrier 100 to be imprinted, the device 100 has a conveyor device 220 in the form of several pairs of conveyor rollers 220a . . . 220h, some of which can be driven at the instigation of the controller. The spacing of the individual rollers of each of the pairs of conveyor rollers 220a . . . 220h is determined such that the carriage 204 with the data carrier 100 located therein is taken up between them and is movable back and forth along the conveying direction F. The data carrier 100 is thus to be moved in the carriage 204 relative to it and the printing head 206. The printing head 206 is able to act upon the area of the data carrier 100 to be imprinted. Alternatively, the carriage 204 can also be arranged on at least one linear guide, wherein the conveyor device 220 can have a toothed belt connected to a drive, which belt can be led around at least one drive pulley and a deflection pulley.

Provided downstream of the printing head 206 in the device 100 is a curing station 230 spatially remote from the printing head 206. It is also provided in one variant to connect the curing station 230 directly to the printing head 206.

The control device 300 is adapted and programmed to cause all or some of the rollers of the pairs of conveyor rollers 220a . . . 220h of the conveyor device 220 to move the data carrier 100 in the carriage 204 relative to the printing head 206. The printing head 206 is thus able to imprint the area of the data carrier to be imprinted. The control device 300 is also adapted and programmed to cause the printing head 206 to imprint the area of the data carrier 100 to be imprinted with personal data using at least a first of the inks.

The control device 300 is also adapted and programmed, once the print process of the personal data using the first inks “Cyan”, “Magenta”, “Yellow” and “Key” is complete, to cause the conveyor device 220 to move the data carrier 100 relative to the curing station 230 in a first direction (to the right in FIG. 2a, 2b), so that the curing station 230 is able to act upon the area of the data carrier 100 to be imprinted.

The curing station 230 comprises a field with UV light sources 232, as UV LEDs in the variant shown. The control device 300 is also adapted and programmed, when the data carrier is located in the area of the curing station 230, to activate the latter and to cause at least partial surface drying of the first ink(s) in the area of the data carrier 100 to be imprinted. This process of surface drying the first ink lasts in the range of a few milliseconds to milliseconds depending on the ink and lacquer.

The control device 300 is also adapted and programmed, following the drying, to cause the conveyor device 220 to move the data carrier 100 relative to the printing head 206 in a second direction opposite to the first (to the left in FIG. 2a, 2b), so that the printing head 206 is able to imprint the area of the data carrier 100 to be imprinted.

The control device 300 is also adapted and programmed, as soon as the data carrier 100 is again located in the access range of the printing head 206, to cause the printing head 206 to imprint the area of the data carrier 100 to be imprinted using at least a second of the inks, here the ultraviolet-light-active ink.

A second print process then takes place with the ultraviolet-light-active ink. The imprint (text, photo, graphics) using the second ink mostly differs from the imprint using at least a first of the inks.

The control device 300 is also adapted and programmed, as soon as the imprinting process using the ultraviolet-light-active ink has finished, to cause the conveyor device 220 to remove the data carrier 100 in the carriage 204 from the device 100. If the conveyor device 220 removes the data carrier 100 from the printer in the first direction, the data carrier 100 also passes the curing station 230. In this case at least partial surface drying of the second ink in the area of the data carrier 100 to be imprinted can also take place.

The carriage 204 is used to receive the data carrier 100 before or during entering of the data carrier 100 into the printer 100 and to fix it in its position and orientation. A fixing device is used for this in the form of several blank holders 262, which are provided for the targeted fixing and release of the data carrier 100 in the carriage 204. More precisely, the blank holders 262 are arranged on the inner edge of the carriage 204 and determine the position and angular orientation of the data carrier 100 when the carriage 204 is brought under the printing head 206.

Furthermore, the device 100 is provided with a sensor array 280 of one or more optical cameras, which are adapted and dimensioned to detect before imprinting, thus during equipping and introduction of the carriage 204 with the data carrier 100 and during imprinting of the area of the data carrier 100 to be imprinted, the position of the data carrier 100 relative to the printing head 206 and to signal this to the control device 300. The precise arrangement of the sensor array 280 relative to the other components of the device results from the structural circumstances and is to be determined accordingly.

Based on the sensor signals from the sensor array 280, the control device 300 is further adapted and programmed to cause the conveyor device 220 to adjust the relative position between the printing head 205 and the data carrier 100 depending on the position of the data carrier 100 in the printer. The speed and the angle of rotation of individual rollers of the conveyor roller pairs 220a . . . 220h are adjusted if necessary for this. Alternatively to this, the positional information, i.e. an x- and y-value of e.g. the edge of the passport or of a reference point on the data page 134, is obtained from an image recording of the data carrier 100 and its data page 134 in another variant. It is recognised from this by image processing whether/how far the passport was incorrectly clamped. For a correctly positioned print the print layout is then rotated and/or moved per image processing.

The blank holders 262 on the inner edge of the carriage 204 are also activated or deactivated targetedly to fix the data carrier 100 in the desired orientation and position in the carriage 204 when the data carrier 100 is introduced into the carriage 204 from outside the device 100.

The sensor array 280 in the variant shown is an imaging sensor. It is also possible, however, to use a mechanical, capacitive or other sensor. The sensor array 280 is also adapted and dimensioned in one variant to detect the quality/intensity/positional accuracy of the print image with the first and/or the second of the inks on the area of the data carrier 100 to be imprinted following and/or during the imprinting of the area of the data carrier 100 to be imprinted, and to signal a measure of the quality/intensity/positional accuracy of the print to the control device 300.

In the device 100, the control device 300 is further adapted and programmed, before removal of the data carrier 100 from the printer (device) 100, to cause the conveyor device 220 to move the data carrier 100 relative to the printing head 206 in a second direction opposite to the first, so that the printing head 206 is able to imprint an area of the data carrier 100 to be imprinted.

In the device 100, the control device 300 is further adapted and programmed to cause the printing head 205 to imprint the area of the data carrier 100 to be imprinted using at least a third of the inks. In this case at least one of the third inks is suitable and intended to seal the previously applied first and second inks at least in sections on the area of the data carrier 100 to be imprinted. The third ink can be a UV-light-curable lacquer.

In the device 100, the control device 300 is further adapted and programmed to cause the conveyor device 220 to move the data carrier 100 relative to the curing station 230 in the first direction after the data carrier 100 has been imprinted with the at least one, third ink. The curing station 230 is thus able to act upon the area of the data carrier 100 to be imprinted.

In the device 100, the control device 300 is further adapted and programmed to subsequently cause the curing station 230 to at least partially surface dry the at least one, third ink in the area of the data carrier 100 to be imprinted in the curing station 230.

In the device 100, the control device 300 is further adapted and programmed to cause the fixing device 260 to release the fixing of the data carrier 100 in the carriage 204 before or after the last, at least partial surface drying. In the variant illustrated here, the fixing and release of the fixing of the data carrier 100 in the carriage 204 is coupled temporally and spatially to the movement of the carriage 204 relative to the printer by the conveyor device 220.

In the device 100, the control device 300 is further adapted and programmed to cause the conveyor device 220 to bring about appropriate dwell times of the data carrier 100 in the curing station 230 depending on the respective one of the inks previously printed onto the data carrier 100 for the respective at least partial surface drying of the inks. For example, the controller 300 can be adapted such that the imprinting of the third ink onto the data carrier 100 or the imprinting of an ink from a previously defined tank effects a longer dwell time of the data carrier 100 in the curing station 230.

Finally, in the device 100, the control device 300 is further adapted and programmed to hold the printing head 205 stationary or to reposition it when imprinting the area of the data carrier 100 to be imprinted and a print field located adjacent to the area to be imprinted, here on the adjacent page 136, with one of the inks.

The variants of the device described above and their design and operational aspects serve only for a better understanding of the structure, mode of operation and properties; they do not restrict the disclosure to the embodiments. The figures are partly schematic, wherein substantial properties and effects are depicted significantly enlarged in part, in order to clarify the functions, active principles, technical configurations and features. Each mode of operation, each principle, each technical configuration and each feature that is/are disclosed in the figures or in the text can be combined freely and in any way with all claims, each feature in the text and in the other figures, other modes of operation, principles, technical configurations and features that are contained in this disclosure or result from it, so that all conceivable combinations are to be associated with the method described. Combinations between all individual implementations in the text, meaning in each section of the description, in the claims and even combinations between different variants in the text, in the claims and in the figures are also comprised in this case. Nor do the claims limit the disclosure and thus the combination possibilities of all features shown with one another. All disclosed features are explicitly disclosed here also individually and in combination with all other features.

1. Method for imprinting a data carrier having the steps:
introduction of the data carrier, with an area to be imprinted exposed, into a printer, wherein assigned to the printer is a printing head with two or more inks to be printed onto the data carrier, and a curing station spatially remote from the printing head;
moving the data carrier relative to the printing head, so that the printing head is able to imprint an area of the data carrier to be imprinted;
imprinting of the area of the data carrier to be imprinted with personal data using at least a first of the inks;
moving the data carrier relative to the curing station in a first direction after the data carrier has been imprinted with the at least one first ink, so that the curing station is able to act upon the area of the data carrier to be imprinted;
at least partial surface drying of the at least one first ink in the area of the data carrier to be imprinted in the curing station;
moving the data carrier relative to the printing head in a second direction opposite to the first direction, so that the printing head is able to imprint an area of the data carrier to be imprinted;
imprinting of the area of the data carrier to be imprinted using at least a second of the inks, wherein preferably the imprint using at least a second of the inks differs from the imprint using at least a first of the inks;
removal of the data carrier from the printer.

2. Method for imprinting a data carrier according to claim 1, wherein upon removal of the data carrier, the step is carried out:
transporting the data carrier from the printer in the first direction, wherein the data carrier passes the curing station and thereby at least partial surface drying of the at least one second ink in the area of the data carrier to be imprinted takes place in the curing station.

3. Method for imprinting a data carrier according to claim 1 or 2, wherein before or during introduction of the data carrier into the printer, the steps are carried out:
receiving the data carrier in a carriage, and
fixing the data carrier in the carriage in a predetermined position.

4. Method for imprinting a data carrier according to any one of claims 1 to 3, wherein before and/or during imprinting of the area of the data carrier to be imprinted with at least the first and/or the second of the inks, the steps are carried out:
detecting the position of the data carrier in the printer, and
depending on the position of the data carrier in the printer, adjusting a relative position between the printing head and the data carrier.

5. Method for imprinting a data carrier according to any one of claims 1 to 4, wherein after and/or during imprinting of the area of the data carrier to be imprinted, the steps are carried out:
detecting the quality and/or intensity and/or positional accuracy of the imprint with at least the first and/or the second of the inks on the area of the data carrier to be imprinted in the printer; and
outputting a measure of the quality and/or intensity and/or positional accuracy of the imprint.

6. Method for imprinting a data carrier according to any one of claims 1 to 5, wherein as
the at least first ink, three inks with the colour components “Cyan”, “Magenta”, “Yellow” and an ink black component “Key” are used, wherein these inks are ultraviolet-light-curable inks; and/or as
the at least second ink, an ultraviolet-light-active ink and/or an ultraviolet-light-curable ink is used, wherein this at least second ink preferably as an ultraviolet-light-active ink is at least virtually invisible in daylight, and fluoresces under ultraviolet light (approximately 254-370 nanometre wavelength).

7. Method for imprinting a data carrier according to any one of claims 1 to 6, wherein before removing the data carrier from the printer, the steps are carried out:
moving the data carrier relative to the printing head in a second direction opposite to the first, so that the printing head is able to imprint an area of the data carrier to be imprinted;
imprinting the area of the data carrier to be imprinted with at least a third of the inks; wherein the at least one of the third inks seals the previously applied first and second inks, at least in sections;
moving the data carrier relative to the curing station in the first direction after the data carrier has been imprinted with the at least one, third ink, so that the curing station is able to act upon the imprinted area of the data carrier;
at least partial surface drying of the at least one, third ink in the area of the data carrier to be imprinted in the curing station.

8. Method for imprinting a data carrier according to any one of claims 3 to 7, wherein at least one of the steps is carried out:
releasing the fixing of the data carrier in the carriage before or after the last, at least partial surface drying, wherein preferably the fixing and the release of the fixing of the data carrier in the carriage is coupled to the movement of the carriage relative to the printer;
determining the respective dwell times dependent on the inks of the data carrier in the curing station for the respective at least partial surface drying of the inks;
holding stationary or repositioning the printing head during imprinting of the area of the data carrier to be imprinted and/or a print field located next to the area to be imprinted with one of the inks.

9. Method for imprinting a data carrier with the steps:
introduction of the data carrier, with an area to be imprinted exposed, into a printer, wherein assigned to the printer is a printing head with two or more inks to be printed onto the data carrier, and a curing station spatially remote from the printing head,
moving the data carrier relative to the printing head in a first direction and imprinting of the area of the data carrier to be imprinted with personal data using at least a first of the inks;
moving the data carrier relative to the curing station in the first direction and at least partial surface drying of the at least one first ink in the area of the data carrier to be imprinted in the curing station;
moving the data carrier relative to the printing head in a second direction opposite to the first direction and imprinting the area of the data carrier to be imprinted using at least a second of the inks.

10. A device for imprinting a data carrier with:
a printer input, which is adapted and dimensioned to receive a data carrier with an exposed area to be imprinted;
a printing head, which is adapted to imprint two or more inks to be printed in a controlled manner onto the exposed area of the data carrier to be imprinted; and
a curing station, which is spatially remote from the printing head;
a conveyor device, which is adapted and dimensioned to move the data carrier, the printing head and the curing station relative to one another so that the printing head is able to imprint the area of the data carrier to be imprinted, and the curing station is able to act upon the imprinted area of the data carrier;
a control device, which is adapted and programmed
to cause the conveyor device to move the data carrier relative to the printing head, so that the printing head is able to imprint the area of the data carrier to be imprinted;
to cause the printing head to imprint the area of the data carrier to be imprinted with personal data using at least a first of the inks;
to cause the conveyor device to move the data carrier relative to the curing station in a first direction after the data carrier has been imprinted using the at least one first ink, so that the curing station is able to act upon the area of the data carrier to be imprinted;
to cause the curing station to at least partially surface dry the at least one first ink in the area of the data carrier to be imprinted;
to cause the conveyor device to move the data carrier relative to the printing head in a second direction opposite to the first, so that the printing head is able to imprint the area of the data carrier to be imprinted;
to cause the printing head to imprint the area of the data carrier to be imprinted using at least a second of the inks, wherein preferably the imprint using at least a second of the inks differs from the imprint using at least a first of the inks; and
to cause the conveyor device to remove the data carrier from the printer.

11. The device for imprinting a data carrier according to claim 10, in which the control device is adapted and programmed
to cause the conveyor device to transport the data carrier from the printer in the first direction, wherein the data carrier passes the curing station and thereby at least partial surface drying of the at least one, second ink in the area of the data carrier to be imprinted takes place in the curing station.

12. The device for imprinting a data carrier according to claim 10 or 11, with
a carriage, which is adapted and dimensioned to receive the data carrier before or during introduction of the data carrier into the printer; and/or
a fixing device, which is adapted and dimensioned to fix the data carrier in the carriage in a predetermined position.

13. The device for imprinting a data carrier according to claim 10, 11 or 12, with
an optical and/or mechanical sensor, which is adapted and dimensioned to detect the position of the data carrier in the printer before and/or during imprinting of the area of the data carrier to be imprinted with at least the first and/or the second of the inks, and to signal this to the control device; and wherein
the control device is adapted and programmed to cause the conveyor device and/or the fixing device to adjust the relative position between the printing head and the data carrier depending on the position of the data carrier in the printer.

14. The device for imprinting a data carrier according to any one of claims 10 to 13, with
a sensor, which is preferably imaging and is adapted and dimensioned to detect, after and/or during imprinting of the area of the data carrier to be imprinted, the quality and/or intensity and/or positional accuracy of the print using at least the first and/or the second of the inks on the area of the data carrier to be imprinted, and to signal a measure of the quality and/or intensity and/or positional accuracy of the print to the control device.

15. The device for imprinting a data carrier according to any one of claims 10 to 14, wherein
the printing head contains three inks in separate compartments with the colour constituents “Cyan”, “Magenta”, “Yellow” and an ink black component “Key” as at least a first ink, wherein these inks are ultraviolet-light-curable inks; and contains an ultraviolet-light-active ink and/or an ultraviolet-light-curable ink in a separate compartment as the at least second ink, wherein this at least second ink preferably as an ultraviolet-light-active ink is at least virtually invisible in daylight, and fluoresces under ultraviolet light (approximately 254-370 nanometre wavelength).

16. The device for imprinting a data carrier according to any one of claims 10 to 15, in which the control device is adapted and programmed, before removal of the data carrier from the printer,
to cause the conveyor device to move the data carrier relative to the printing head in a second direction opposite to the first so that the printing head is able to imprint an area of the data carrier to be imprinted;
to cause the printing head to imprint the area of the data carrier to be imprinted with at least a third of the inks; wherein the at least one of the third inks seals the previously applied first and second inks, at least in sections;
to cause the conveyor device to move the data carrier relative to the curing station in the first direction after the data carrier has been imprinted with the at least one, third ink, so that the curing station is able to act upon the area of the data carrier to be imprinted;
to cause the curing station to at least partially surface dry the at least one, third ink in the area of the data carrier to be imprinted in the curing station.

17. The device for imprinting a data carrier according to any one of claims 10 to 16, in which the control device is adapted and programmed
to cause the fixing device to release the fixing of the data carrier in the carriage before or after the last, at least partial surface drying, wherein preferably the fixing and the release of the fixing of the data carrier in the carriage is coupled to the movement of the carriage relative to the printer by the conveyor device;
to cause the conveyor device to bring about, depending on the respective of the inks, the corresponding dwell time of the data carrier in the curing station for the respective at least partial surface drying of the inks;
to hold stationary or reposition the printing head during imprinting of the area of the data carrier to be imprinted and/or a print field located next to the area to be imprinted with one of the inks.
